(19) United States
(12) Patent Application Publication
(10) Pub. No.: US 2007/0103617 A1
(43) Pub. Date: May 10, 2007

(54) Display unit

(76) Inventors: Yasuo Kitajima, Sayama-shi (JP); Yuichi Kato, Tokyo (JP); Yuichi Hasumi, Sayama-shi (JP)

Correspondence Address: SMITH, GAMBRELL & RUSSELL, 1850 M STREET, N.W., SUITE 800, WASHINGTON, DC, 20036, US

(21) Appl. No.: 11/642,909

(22) Filed: Dec. 21, 2006

Related U.S. Application Data
(62) Division of application No. 10/962,465, filed on Oct. 13, 2004.

(30) Foreign Application Priority Data
Oct. 15, 2003 (JP) 355583/2003

(51) Int. Cl. G02F 1/1333

(52) U.S. Cl. 349/58

(57) ABSTRACT

A shield member that shields both of or one of an electricity and a magnetism is provided between a circuit board and a display panel arranged to be superposed on the circuit board. A holding portion that holds a lighting device is formed on one side of that shield member. The lighting device stored in this holding portion is positioned relative to a side surface of the display panel.

### BACKGROUND OF THE INVENTION

1. Field of the Invention

The present invention relates to a display unit that includes a liquid crystal display panel and a lighting device that causes a light to be incident on a side surface of the liquid crystal display panel.

2. Description of the Related Art

A liquid crystal display panel is not a self-luminous display unit. In a dark environment in which a sufficient external light cannot be secured, therefore, a visibility of the liquid crystal display panel should be improved using an auxiliary light source.

As a first example of a display unit that employs such an auxiliary light source, a display unit constituted so that a light guide plate is superposed on an upper portion of the liquid display panel, a linear lighting device is arranged on a side surface of the light guide plate, a light from the lighting device is caused to be incident on the side surface of the light guide plate, and that the light is thereby irradiated from this light guide plate onto an entire surface of the liquid crystal display panel is described in Japanese Patent Application Laid-Open No. 2001-356323. The light guide plate and the liquid crystal display panel are both fixed to a common fixing frame.

As a second example of the display unit that employs the auxiliary light source, a display unit constituted so that a lighting device (a light source) is arranged on a side surface of a liquid crystal display panel (a liquid crystal cell), and that a light from the lighting device is caused to be incident on the liquid crystal cell is described in Japanese Patent Application Laid-Open No. 2001-33766. The display unit in the second example is characterized in that a structure of the display unit can be simplified and a size of the display unit can be reduced since it is unnecessary to arrange a light guide plate above the liquid crystal display. In the second example, it is necessary to ensure that the light from the lighting device is accurately incident on the liquid crystal display panel. To do so, a positional relationship between the lighting device and the liquid crystal display panel should be accurately held. However, the above Japanese patent document fails to describe a structure intended to consider that respect.

### SUMMARY OF THE INVENTION

According to a first aspect of the present invention, there is provided a display unit comprising: a liquid crystal display panel; a lighting device arranged to face one side surface of the liquid crystal display panel, and causing a light to be incident on the side surface of the liquid crystal display panel; and a single support frame that supports the liquid crystal display panel and the lighting device.

The support frame may comprises a flat portion that supports the liquid crystal display panel; and a holding portion that is formed by bending one side edge of the flat portion, and that supports the lighting device. The lighting device comprises a linear light guide member; and a point light source arranged on one end surface of the light guide member. At least the linear light guide member is arranged in the holding portion.

According to a second aspect of the present invention, there is provided a display unit comprising: a circuit board; a liquid crystal display panel arranged to be superposed on the circuit board; a lighting device that is arranged to face one side surface of the liquid crystal display panel, and that causes a light to be incident on the side surface of the liquid crystal display panel; and a single shield member that is arranged between the circuit board and the liquid crystal display panel, and that shields both of or one of an electricity and a magnetism, wherein the shield member supports both the liquid crystal display panel and the lighting device.

The shield member may comprise a flat portion that supports the liquid crystal display panel; and a holding portion that is formed by bending one side edge of the flat portion, and that supports the lighting device. The lighting device comprises a linear light guide member, and a point light source arranged on one end surface of the light guide member, and at least the linear light guide member is arranged in the holding portion of the shield member.

As stated above, according to the present invention, the liquid crystal display panel and the lighting device are supported by one frame, and a light emitted from this lighting device is incident on the side surface of the liquid crystal display panel. Therefore, the position of the lighting device relative to the liquid crystal display panel is stabilized, and it is possible to cause the light to be stably incident on the side surface of the liquid crystal display panel from a correct position in a correct direction. As the frame that supports the liquid crystal display panel and the lighting device, a single shield member that is arranged between the circuit board and the liquid crystal display panel, and that shields both of or one of an electricity and a magnetism can be used. In addition, if the lighting device is composed by the linear light guide member and the point light source, the linear light guide member (and the reflecting member) can be stored in a portion formed by folding one side of the frame (shield member).

### BRIEF DESCRIPTION OF THE DRAWINGS

The above and other objects and features of the present invention will be readily apparent from the following description of embodiments with reference to the accompanying drawings, in which

FIG. 1 is a perspective view of a wristwatch type display unit according to the present invention, composed by a module that includes a display portion, a bezel to which the module is attached, and a band integral with the bezel;

FIG. 2 is a front view which depicts a state in which the display unit shown in FIG. 1 is put on a cradle indicated by a dotted line and in which a secondary battery in the module is charged;

FIG. 3 is an exploded view which depicts a state in which the display unit shown in FIG. 1is disassembled and seen upside down and which explains that an electronic apparatus is assembled by fitting the module into the bezel integral with the band;

FIG. 4 is an exploded view which depicts a state in which the module shown in FIG. 3 is disassembled to show constituent elements of respective portions;

FIG. 5 is a perspective view which depicts a base frame that constitutes the module shown in FIG. 3 from below;

FIG. 6 is a perspective view of a contact plate attached between a circuit board and an intermediate frame constituting the module shown in FIG. 3;

FIG. 7 is a perspective view of the intermediate frame that constitutes the module shown in FIG. 3;

FIG. 8 is a perspective view of a shield member that constitutes the module shown in FIG. 3;

FIG. 9 is a perspective view of a panel member that constitutes the module shown in FIG. 3;

FIG. 10 is a plan view which depicts the module shown in FIG. 3 from above;

FIG. 11 is a plan view which depicts the module shown in FIG. 3 from below;

FIG. 12 is an internal view of a rear cover shown in FIG. 3; and

FIG. 13 is an explanatory view for uniformly illuminating an entire display portion of the panel member in the display unit shown in FIG. 1.

### DESCRIPTION OF THE EMBODIMENTS

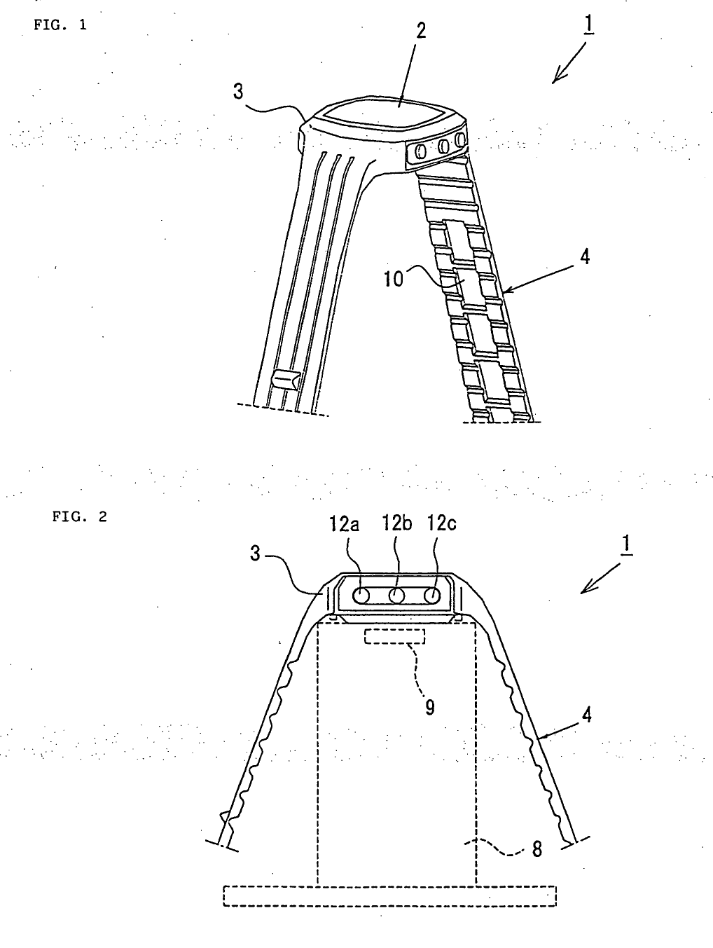

FIG. 1 depicts a wristwatch type display unit 1, which functions as an information terminal that can acquire e-mail and Internet information and that can store and edit data. This display unit 1 is composed by a module 2 that includes a display portion, a bezel 3 to which the module 2 is attached, a band 4, and a rear cover 5. The bezel 3 is an external frame of the module 2. In this embodiment, the bezel 3 and the band 4 are formed integrally with each other using a synthetic resin. As shown in FIG. 3, the bezel 3 is in the form of a container, and provided with a first stepped portion 6 to which the module 2 is attached and a second stepped portion 7 into which the rear cover 5 is fixedly fitted.

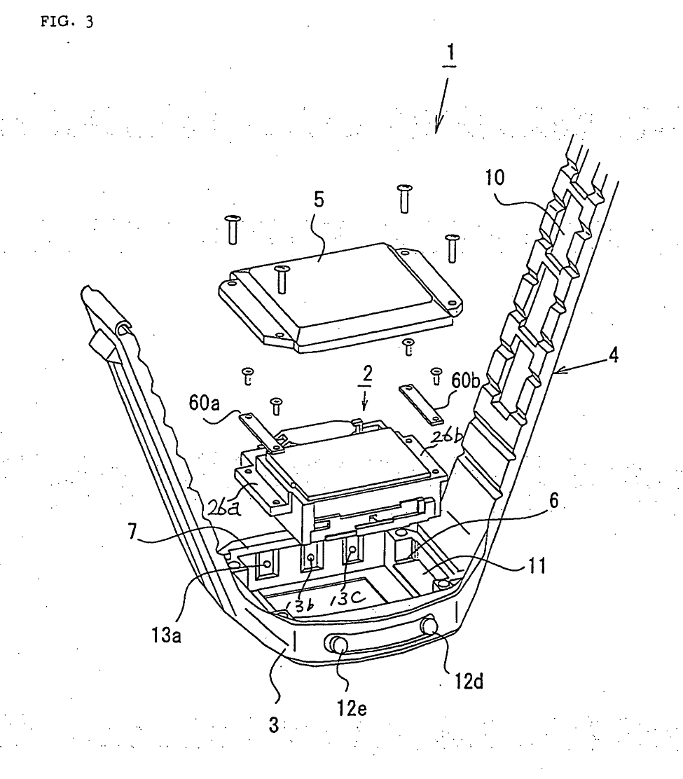

The display unit 1 includes a lithium battery (secondary battery) and a small secondary coil, both of which will be described later, in the module 2. As shown in FIG. 2, the display unit 1 is mounted on a cradle 8, whereby a primary coil 9 in the cradle 8 is electromagnetically coupled with the secondary coil in the module 2, and a lithium battery is charged using an induction electromotive force. The lithium battery is a light source for the entire display unit 1.

A thin conductive strip is embedded in each of the bands 4, thereby forming antennas 10. One end 11 of each antenna 10 is put on the first stepped portion 6 and exposed into the bezel 3. The end 11 of the antenna 10 is connected to an antenna terminal (a surface pattern on the circuit board) exposed toward the module 2 when the module 2 is attached to the bezel 3. The other ends of the respective antennas 10 are connected to each other when the bands 4 are wound around a wrist and the both ends are connected to each other. A loop is thus formed and the loop functions as the antenna.

As shown in FIG. 2, three buttons 12a, 12b, 12c are provided on a front surface of a side surface of the bezel 3 for operating the module 2. FIG. 3 shows that holes 13a, 13b, and 13c through which rods of these buttons 12a, 12b, and 12c are penetrated are formed on a sidewall of the bezel 3. As shown in FIG. 3, two buttons 12d and 12e are provided on a back surface of the side surface of the bezel 3.

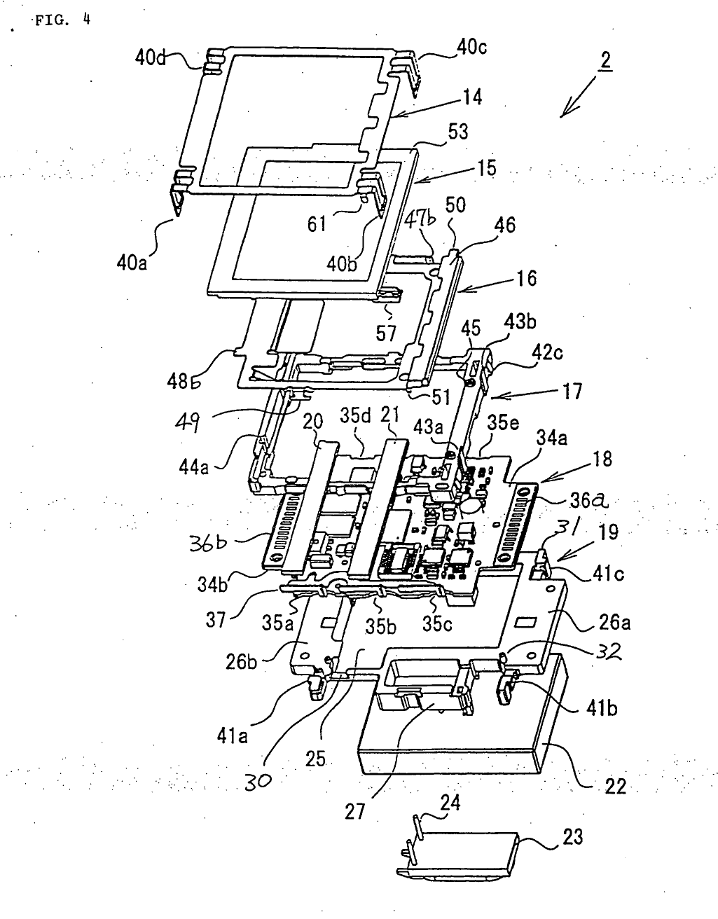

As shown in FIG. 4, the module 2 includes a fixing frame 14, a panel member 15, a shield member 16, an intermediate frame 17, a circuit board 18, and a base frame 19 in this order from above. In FIG. 4, reference numeral 20 denotes a linear light guide member, and reference numeral 21 denotes a reflecting member. These members 20 and 21 constitute an indirect linear lighting device. Reference numeral 22 denotes a lithium battery. Reference numeral 23 denotes a secondary coil, which is contained in a case and two terminals protrudes from the case.

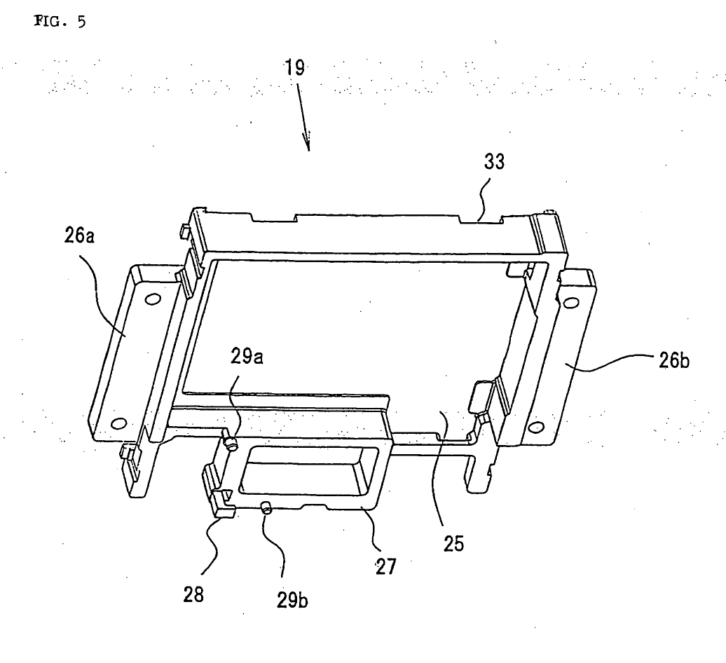

Structures of main elements that constitute the module 2 will be described with reference to FIG. 4 and relevant drawings.

[Base Frame: (FIG. 5)]

The base frame 19 is formed by an ABS resin having a high strength and a high forming accuracy, and includes a battery storage recess 25 that opens downward in a central portion of the base frame 19. A depth of the battery storage recess 25 is substantially equal to a thickness of the lithium: battery 22. The lithium battery 22 is fitted into this battery storage recess 25 from below. A bottom of the battery storage recess 25 is cut out so as to radiate a heat, reduce a weight, and to be used as a resonant space for a piezoelectric buzzer.

Support base portions 26a and 26b protrude outward of a left side and a right side of the base frame 19, respectively. An attachment base 27 for the secondary coil 23 protrudes outward of a front side of the base frame 19. The attachment base 27 for the secondary coil 23 is arranged not to be superposed on the battery storage recess 25 two-dimensionally.

The secondary coil 23 is attached to a lower surface of the attachment base 27. A positioning hook protrusion 28 and a pair of vertical pins 29a and 29b are formed on the lower surface of the attachment base 27. Firstly the case that stores the secondary coil 23 therein is provided so that two sides of the case butt on the vertical pins 29a and 29b respectively and one end of the case is engaged with the hook protrusion 28 to position the case in a vertical direction and a horizontal direction. Through these procedures, the case that stores therein the secondary coil 23 is positioned relative to the attachment base 27 in the vertical direction and the horizontal direction.

As stated, in the display unit, the secondary coil and the lithium battery (secondary cell) are arranged not to be superposed on each other two-dimensionally. Therefore, efficiency for coupling the secondary coil with the lithium battery by electromagnetic induction is improved without interference with each other.

The secondary coil 23 needs to be accurately positioned in the vertical direction and the horizontal direction so that the secondary coil 23 is electromagnetically coupled with the primary coil 9 in the cradle 8 (FIG. 2). It is, therefore, important to set a position and a thickness of the attachment base 27 in the base frame 19.

A recess 30 to which a positioning protrusion 39 of a contact plate 37 (FIG. 6), to be described later, retreats is formed at a position near the attachment base 27 of the base frame 19. A lead wire of the lithium battery 22 is connected to a connector 59 through an upper portion of the base frame 19 in FIG. 11 to be described later.

A positioning protrusion 31 and a vertical pin 32 for positioning the circuit board 18 thus mounted protrude from an upper surface of the base frame 19. Further, notches 33 for exposing a contact surface provided on an edge of the circuit board 18 (or a pattern formed on the circuit board 18) are formed on the upper surface of the base frame 19.

[Circuit Board]

The circuit board 18 includes a printed circuit board, a CPU, a memory, parts responsible for input and output, and the like arranged on the printed circuit board, and a reception circuit for receiving a radio wave. The circuit board 18 is rectangularly flat, and includes flange portions 34a and 34b having shapes and sizes matched to the support base portions 26a and 26b of the base frame 19 on left and right sides of the circuit board 18, respectively. Meshed circuit patterns 36a and 36b are formed widely into sheets on these respective flange portions 34a and 34b. A liquid crystal display panel 53, to be described later, and the linear light guide member 20 are arranged to be superposed on each other in a central portion of the circuit board 18 except for the flange portions 34a and 34b. Further, three contact surfaces 35a, 35b, and 35c are formed on a front edge of the circuit board 18, and two contact surfaces 35d and 35e are formed on a rear edge of the circuit board 18. A grounding surface pattern portion of the circuit board 18 is formed into a mesh.

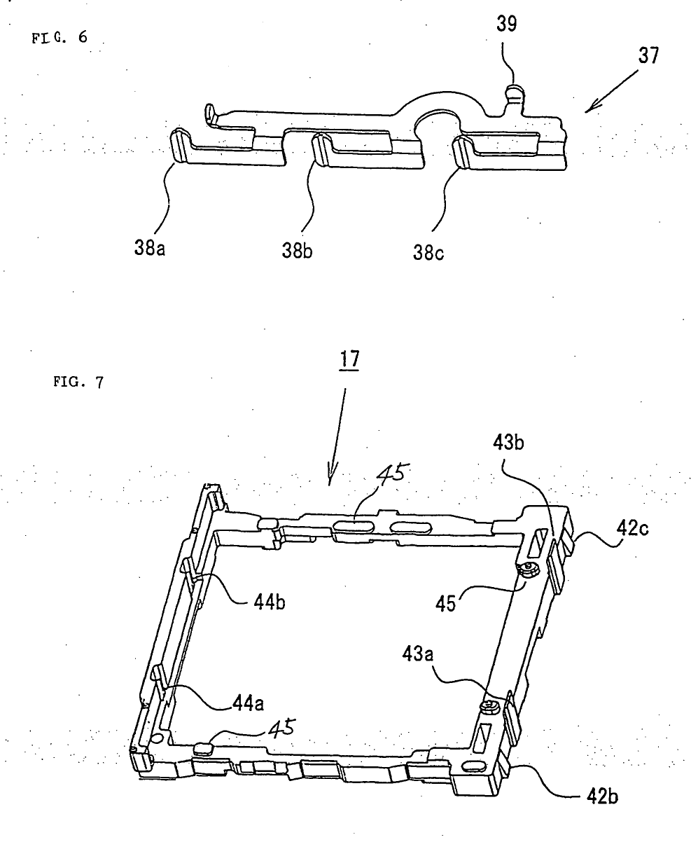

The three contact surfaces 35a, 35b, and 35c formed on the front edge of the circuit board 18 face contact pieces 38a, 38b, and 38c formed on the contact plate 37 (FIG. 6), respectively. This contact plate 37 is a separate member from the circuit board 18, and attached between the circuit board 18 and the intermediate frame 17 while the protrusion 39 is engaged with the intermediate frame 17. When being depressed by buttons 12a, 12b, and 12c shown in FIG. 2, the contact pieces 38a, 38b, and 38c come in contact with the contact surfaces 35a, 35b, and 35c of the circuit board 18, respectively.

[Intermediate Frame: (FIG. 7)]

The intermediate frame 17 is provided to form a gap between the circuit board 18 and the panel member 15, and to protect the parts protruding on the circuit board 18. The shield member 16 and the panel member 15 are superposed on the intermediate frame 17, and the fixing frame 14 is further covered on the panel member 15. At this time, spring hooks 40a, 40b, 40c and 40d provided on left and right sides of the fixing frame 14 are engaged with engagement protrusions 41a, 41b, 41c and 41d provided to slightly protrude in four corners of the base frame 19 (note, however, that the engagement protrusion 41d is invisible in FIG. 4), respectively. By this engagement, the intermediate frame 17 and the circuit board 18 are fixed to each other while being compressed between the fixing frame 14 and the base frame 19.

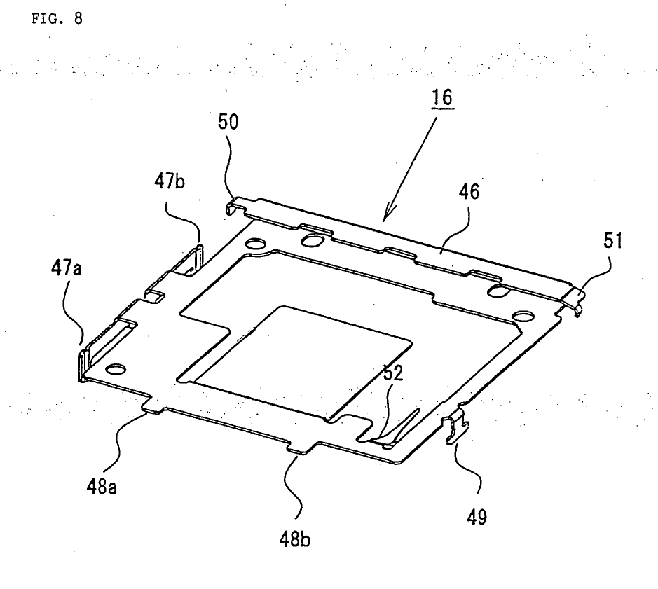

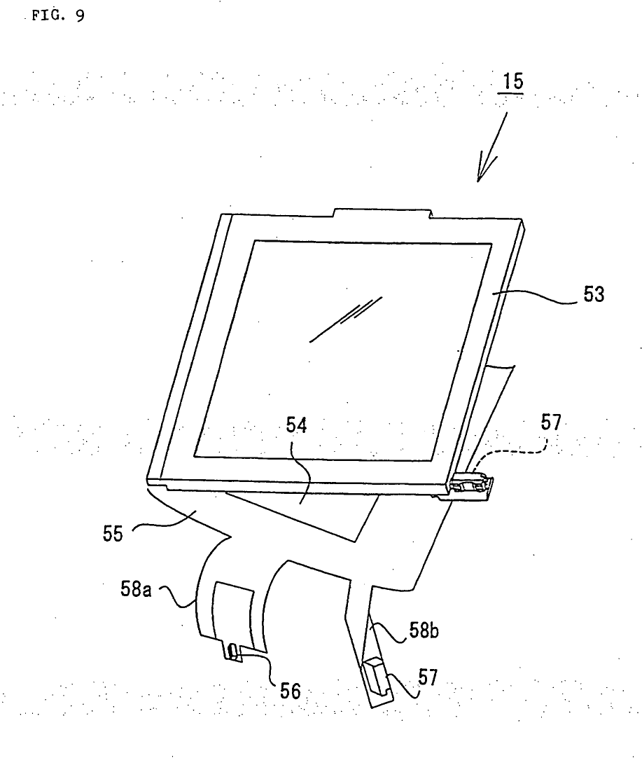

As shown in FIG. 7, guide protrusions 42a, 42b, 42c and 42d that include inclined surfaces for guiding the hooks 40a, 40b, 40c and 40d of the fixing frame 14 to the engagement protrusions 41a, 41b, 41c and 41d of the base frame 19, respectively, are provided on left and right sides of the intermediate frame 17 (note, however, that the guide protrusions 42a and 42b are invisible in FIG. 7). Further, a pair of protrusion guides 43a and 43b are formed on the right side of the intermediate frame 17, and a pair of engagement holes 44a and 44b are formed on the left side of the intermediate frame 17. The protrusion guides 43a and 43b and the engagement holes 44a and 44b are used for positioning the shield member 16 relative to the intermediate frame 17. In addition, a plurality of spacer protrusions 45 are formed on an upper surface of the intermediate frame 17.

[Shield Member: (FIG. 8)]

The shield member 16 is provided to protect a liquid crystal drive control portion 54 (FIG. 9) of the liquid crystal display panel, to be described later, that constitutes the panel member 15 from an electromagnetic noise from the circuit board 18. The shield member 16 is a thin stainless steel frame member. Since the shield member 16 is the member that shields at least one of an electricity and a magnetism as stated above, an area of a punched part is made as small as possible. As shown in FIG. 9, the liquid crystal drive control portion 54 of the liquid crystal display panel is provided on a flexible printed circuit (FPC) 55 arranged on a lower surface of the liquid crystal display panel 53.

A holding portion 46 having a U-shaped cross section is formed on a right side of the shield member 16 by vertically raising a right side portion of the shield member 16 over its entire length and then bending the right side portion inward. On the other hand, protrusion pieces 48a and 48b inserted into the engagement holes 44a and 44b of the intermediate frame 17 protrude outward of a left side of the shield member 16. One engagement piece 49 is formed downward of a front side of the shield member 16. A pair of protrusions are formed to protrude outward and bend downward of a rear side of the shield member 16, and contact pieces 47a and 47b are formed on one side ends of parts bent downward of the paired protrusions, respectively. The contact pieces 47a and 47b are depressed by the buttons 12d and 12e shown in FIG. 3 to be brought into contact with the contact surfaces 35d and 35e of the circuit board 18, respectively. A central portion of the shield member 16 except for the holding portion 46, the contact pieces 47a and 47b, the protrusion pieces 48a and 48b, and the engagement protrusion 49 is formed into a flat portion.

Each of the contact pieces 47a and 47b and the engagement protrusion 49 exhibits a spring performance. When the shield member 16 is forced into the intermediate frame 17 from above, the front and rear sides of the intermediate frame 17 are put between the contact pieces 47a an 47b and the engagement protrusion 49. Therefore, the shield member 16 can be-stably held into the intermediate frame 17.

As shown in FIG. 8, a stopper 50 having a tip end bent downward protrudes from a rear end of an upper portion of the holding portion 46-formed on the right side of the shield member 16 and having the U-shaped cross section, and an LED fixing piece 51 protrudes from a front end of the upper portion of the holding portion 46.

The linear light guide member 20 is a transparent rectangular solid. The linear light guide member 20 is stored in the holding portion 46 while being put between parts of the reflecting member 21 bent to have a U-shaped cross section. Namely, the linear light guide member 20 and the reflecting member 21 between parts of which the member 20 is put are inserted into the holding portion 46 from a front end of the holding portion 46 (or from an end portion on a side on which the LED fixing piece 51 is formed), slidably moved in the holding portion 46, and positioned relative to the holding portion 46 while one end of the linear light guide member 20 and one end of the reflecting member 21 butt on the stopper 50.

Further, the shield member 16 includes a tongue piece 52 having a spring performance and bent downward so as to be grounded. A lower end of this tongue piece 52 is designed to come in contact with a grounding surface pattern portion of the circuit board 18 when the assembling of the module is completed.

[Panel Member: (FIG. 9)]

The panel member 15 is composed by the liquid crystal display panel 53 and the FPC 55 that includes the drive control portion 54 for the liquid crystal display panel 53. Each cell of the liquid crystal display panel 53 is not a square but normally a rectangle having left and right sides, which are long sides, and front and rear sides, which are short sides, as shown in FIG. 9. Therefore, a connection portion in which the FPC 55 is connected to the liquid crystal display panel 53 is arranged on the left side of the panel member 15 corresponding to one of the long sides of the liquid crystal display panel 53. In addition, the holding portion 46 that stores therein the linear light guide member 20 and the reflecting member 21 is arranged on the right side of the shield member 16 corresponding to the other long side of the liquid crystal display panel 53. The entire module 2 is thereby formed into a shape similar to a square, whereby a shape balance as the display unit is kept.

As shown in FIG. 9, a first branch portion 58a and a second branch portion 58b are branched from a main portion of the FPC 55. A connector portion 56 (connection line) connected to the circuit board 18 is provided on a tip end of the first branch portion 58a, and an LED 57 (a point light source) is attached to a tip end of the second branch portion 58b. The main portion of the FPC 55 is bent and superposed on a rear surface of the liquid crystal display panel 53. The liquid crystal drive control section 54 is formed in the main portion of the FPC 55.

By twisting the second branch portion 58b, the LED 57 is located on a front end of the right side of the liquid crystal display panel 53, that is, located on a front end of the shield member 16 (the holding portion 46). A light emitting surface of the LED 57 is directed rearward and in contact with the end of the linear light guide member 20 held in the holding portion 46 of the shield member 16.

Rear ends of the linear light guide member 20 and the reflecting member 21, attached into the holding portion 46 of the shield member 16, are stopped by the stopper 50 so as to prevent detachment, and front ends thereof are temporarily stopped by the LED fixing piece 51. A second stopper 61 (FIG. 4) formed downward on a front side of the fixing frame 14 abuts on an outside of this LED fixing piece 51, thereby pressing down the LED fixing piece 51 that temporarily stops the linear light guide member 20 and the reflecting member 21, from outside.

[Formation of Module]The circuit board 18, the intermediate frame 17, the shield member 16, and the panel member 15 are sequentially stacked on the base frame 19 in this order. The fixing frame 14 is covered on the panel member 15, and the circuit board 18, the intermediate frame 17, the shield member 16, and the panel member 15 are fastened between the panel member 15 and the base frame 19, thereby forming the module 2.

To form this module 2, the linear light guide member 20 and the reflecting member 21 are incorporated into the holding portion 46 of the shield member 16 in advance. The panel member 15 is superposed on the shield member 16, the LED 57 is put on the front end of the holding portion 46, and the LED fixing piece 51 is crimped, thereby fixing the LED 57 into the holding portion 46.

The FPC 55 of the liquid crystal display panel 53 is folded so that the drive control portion 54 is located below the liquid crystal display panel 53. The connector portion 56 on the tip end of the FPC 55 is inserted downward from the central punched part of the shield member 16, thereby coupling the connector portion 56 with a connector of the circuit board 18.

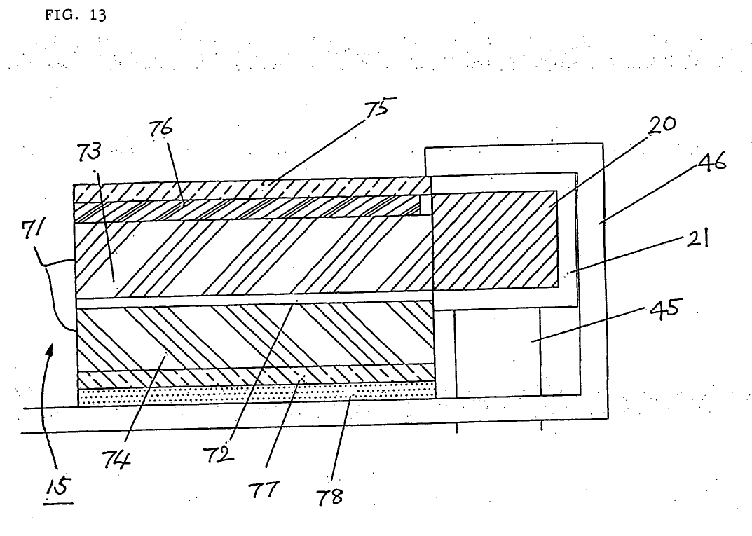

When the panel member 15 is attached to the shield member 16, the right side of the panel member 15 is connected to one end surface of the linear light guide member 20 stored in the holding portion 46 of the shied member 16. As a result, the display portion of the panel member 15 receives a light from the LED 57 through the linear light guide member 20 and also receives a light (leakage light) reflected by the reflecting member 21. How the display portion of this panel member 15 is illuminated will now be described in detail with reference to FIG. 13.

A substrate 71 of the panel member 15 is composed by a liquid crystal panel upper glass 73 and a liquid crystal panel lower glass 74. The upper glass 73 is arranged to be superposed on the lower glass 74 with a liquid crystal gap 72 put there between. A thin sheet light guide member 76 (prism sheet) is formed between a surface of the substrate 71 and an upper polarizer 75. A reflecting plate 78 is bonded to a rear surface of the substrate 71 through a lower polarizer 77. A light emitted from the LED 57 is incident on a side surface of the substrate 71 of the panel member 15 from the linear light guide member 20, guided from right to left of the panel member 15 shown in FIG. 9 while being reflected and refracted between the sheet light guide member 76 on the surface of the panel member 15 and the reflecting plate 78 on the rear surface of the substrate 71, whereby the entire display portion of the panel member 15 is uniformly illuminated. According to this embodiment, therefore, as shown in FIG. 13, (1) the linear light guide member 20 is connected to the side surface of the substrate 71 that constitutes the panel member 15. In addition, (2) the light emitted from the LED 57 and incident on the side surface of the substrate 71 of the panel member 15 is illuminated on the entire surface of the substrate 71 while being reflected between the sheet light guide member 76 on the surface of the substrate 71 and the reflecting plate 78 on the rear surface of the substrate 71, and using the substrate 71 itself as a part of the light guide member. In the example of FIG. 13, the linear light guide member 20 is connected to only the side surface of the liquid crystal panel upper glass 73 that constitutes the substrate 71. Alternatively, the linear light guide member 20 may be connected to the side surface of the liquid crystal panel upper glass 73 and that of the liquid crystal lower glass 74. As can be seen, the panel member 15 is connected to the linear light guide member 20, while the panel member 15 and the linear light guide member 20 are positioned based on the shield member 16. Therefore, the connection between the panel member 15 and the linear light guide member 20 is accurately made.

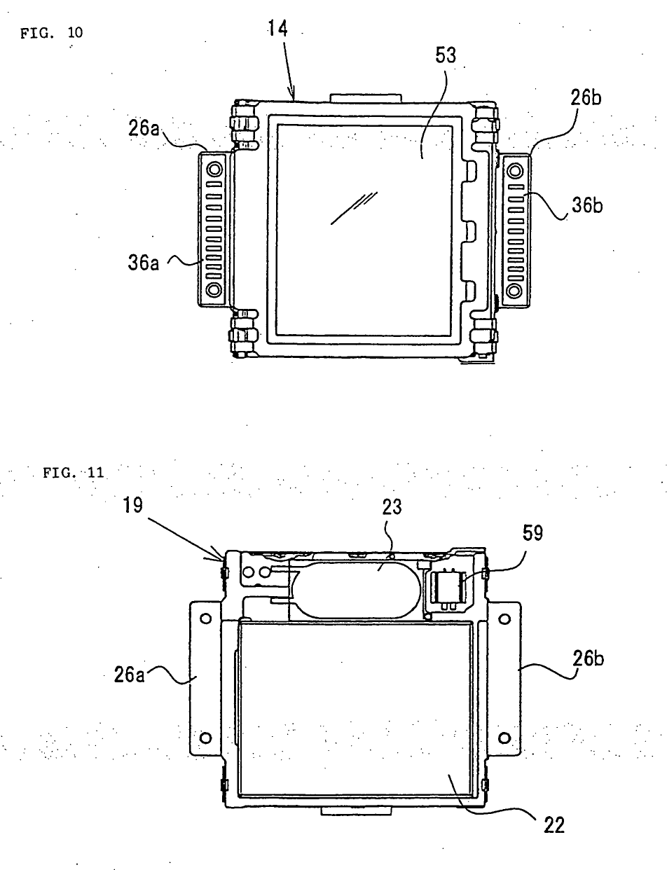

As is obvious from FIGS. 10 and 11 which depict the completed module 2 from above and below, respectively, the main part of the module 2 is substantially square in a plain view. The support base portions 26a and 26b of the base frame 19 protrude from left and right sides of the main part of the module 2, respectively. As shown in FIG. 10, the meshed circuit patterns 36a and 36b are formed on upper surfaces of the left and right support base portions 26a and 26b, respectively. When the module 2 is viewed from below, the lithium battery 22 and the secondary coil 23 are seen as shown in FIG. 11. In FIG. 11, reference numeral 59 denotes a connector, which connects the circuit substrate 18 to the lithium battery 22.

The completed module 2 is fitted into the bezel 3 integral with the bands 4. Reinforcing members 60a and 60b are fitted to the left and right support base portions 26a and 26b of the base frame 19 and fixed thereto by screws. At this time, the flange portions 34a and 34b of the circuit board 18 are located above the left and right support base portions 26a and 26b of the base frame 19. The meshed circuit patterns 36a and 36b formed on the flange portions 34a and 34b are connected to the antenna ends 11 of the bands 4, thereby connecting the antennas 10 to the circuit of the circuit board 18, respectively. The rear cover 5 is covered on the module 2 and fixed onto the module 2 by screws.

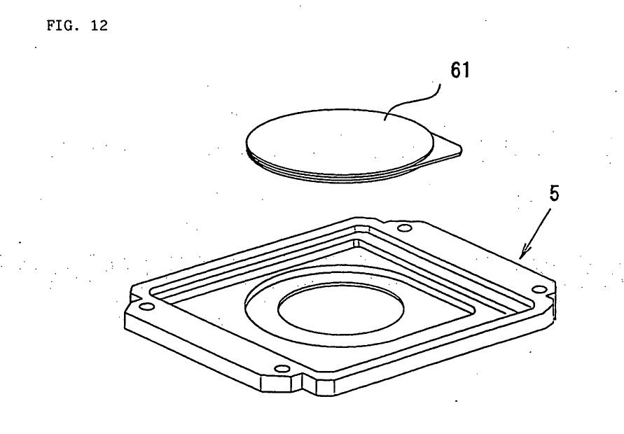

The rear cover 5 consists of the same synthetic resin as that for the bezel 3. As shown in FIG. 12, the piezoelectric buzzer 61 consisting of piezoceramic or the like is arranged on an inside surface of the rear cover 5. This piezoelectric buzzer 61 is located below the lithium battery 22 so as to avoid superposition of the buzzer 61 on the secondary coil 23 attached to the lower surface of the attachment base 27 of the base frame 19 as much as possible. In other words, the attachment base 27 for attaching the secondary coil 23 is arranged at a position so that the attachment base 27 is not superposed on the piezoelectric buzzer 61 two-dimensionally.

A space between the rear cover 6 and the lithium battery 22 as well as the bottom of the battery storage recess 25 forms the resonant space for the piezoelectric buzzer 61.

Finally, the rods of the buttons 12ato 12c (FIG. 2) and the buttons 12d and 12e (FIG. 3) are inserted from the through holes 13ato 13c and the through holes 13d and 13e (note, however, that the through holes 13d and 13e are invisible in FIG. 3), respectively. The contact pieces 38a to 38c (FIG. 6) and the contact pieces 47a and 47b (FIG. 8) are depressed by tip ends of these rods, whereby the contact pieces 38a to 38c and 47a and 47b are allowed to come in contact with the contact surfaces 35a to 35e of the circuit board 18. The contact pieces 38a to 38c, 47a, and 47b exhibit spring performances. Therefore, when a force of depressing the buttons 12a to 12e is weakened, the rods are pushed back and the buttons 12a to 12e are returned to their original positions.

As stated so far, the lighting device and the liquid crystal display panel are both attached to the shield member 16, and positioned accurately relative to the shield member 16. Therefore, the lighting device and the liquid crystal display panel can be easily assembled and the illumination can be efficiently utilized.

Since the lighting device is directly attached to one side of the liquid crystal display panel, there is no need to provide a light guide plate that ranges over the entire surface of the liquid crystal panel. The display unit can be thereby made thin.

Moreover, the lighting device is stored in the holding portion 46 formed as a part of the shield member 16. Since the lighting device is attached to such a relatively large member, the auxiliary light source can be easily formed. In addition, if the lighting device is constituted to include the linear light guide member 20 and the reflecting member 21, and the linear light guide member 20 and the reflecting member 21 are inserted into the holding portion 46, the members 20 and 21 are positioned by the stopper 50. Besides, since the LED fixing piece 51 is provided, the positioning and fixing of the LED 57 to the linear light guide member 20 can be easily made.

1-7. (canceled)

8. A display unit comprising:
a circuit board;
a liquid crystal display panel arranged to be superposed on said circuit board;
a lighting device that is arranged to face one side surface of said liquid crystal display panel, and that causes a light to be incident on the side surface of said liquid crystal display panel; and
a single shield member that is arranged between said circuit board and said liquid crystal display panel, and that shields both of or one of an electricity and a magnetism, wherein
said shield member supports both said liquid crystal display panel and said lighting device.

9. The display unit according to claim 8, wherein
said shield member comprises:
a flat portion that supports said liquid crystal display panel; and
a holding portion that is formed by bending one side edge of the flat portion, and that supports said lighting device.

10. The display unit according to claim 9, wherein
said lighting device comprises:
a linear light guide member; and
a point light source arranged on one end surface of the light guide member, and wherein
at least the linear light guide member is arranged in said holding portion of the shield member.

11. The display unit according to claim 10, wherein
said holding portion of said shield member comprises a first stopper that is formed on one end of said holding portion in a length direction, and that abuts on one end of said light guide member to restrict the light guide member from protruding out of the holding portion.

12. The display unit according to claim 11, wherein
said holding portion of said shield member comprises:
a first stopper that is formed on one end of said holding portion in a length direction, and that abuts on one end of said light guide member to restrict the light guide member from protruding out of the holding portion; and
a fixing piece that is formed on the other end of said holding portion in the length direction, and that fixes said point light source.

13. The display unit according to claim 8, wherein
one or a plurality of contact surfaces are formed on one side of said circuit board, and one or a plurality of contact pieces are formed on one side of said shield member to correspond to the one or the plurality of contact surfaces, respectively.

14. The display unit according to claim 8, wherein
a flexible printed circuit is connected to one side of said liquid crystal display panel, and a display panel driving circuit provided on the flexible printed circuit is arranged on a surface of the liquid crystal display panel which faces said circuit board, and
an opening is formed in a region of said shield member which region does not face said display panel driving circuit, and said circuit board is connected to said liquid crystal display panel by the flexible printed circuit through the opening.

15. The display unit according to claim 8, wherein
said circuit board comprises a reception circuit that receives a radio wave, and circuit patterns are formed on left and right side portions of the circuit board so as to be connected to antenna ends, respectively.

16. The display unit according to claim 15, wherein
said circuit board comprises:
a central portion on which said liquid crystal display panel is arranged to be superposed; and
flange portions protruding left and right of the central portion, respectively, and wherein
said circuit patterns are formed on the flange portions, respectively.

17. The display unit according to claim 8, further comprising:
a holding frame that holds a secondary battery and a secondary coil used to charge the secondary battery, wherein
the secondary battery and the secondary coil are held by said holding frame at positions at which the secondary battery and the secondary coil are not superposed two-dimensionally.

18. The display unit according to claim 17, wherein
said holding frame is composed by a generally rectangular main body portion, and an attachment base protruding outward of a side of the main body portion,
said secondary battery is fitted into a recess formed in said main body portion, and said secondary coil is attached to said attachment base.

19. A display unit comprising:
a circuit board;
a liquid crystal display panel arranged to be superposed on said circuit board;
a lighting device arranged to face one side surface of said liquid crystal display panel, and causing a light to be incident on the side surface of said liquid crystal display panel;
a shield member that is arranged between said circuit board and said liquid crystal display panel, and that shields both of or one of an electricity and a magnetism; and
an upper fixing frame and a lower fixing frame for putting said circuit board, said shield member and said liquid crystal display panel between the upper fixing frame and the lower fixing frame, wherein
said shield member comprises:
a flat portion that supports said liquid crystal display panel; and
a holding portion that is formed by bending one side edge of the flat portion, and that supports said lighting device, and wherein
a first stopper that abuts on one end of said light guide member to restrict the light guide member from protruding out of the holding portion is formed on one end of said holding portion of the shield member in a length direction of the holding portion, and
a second stopper that restricts said light guide member from protruding out of the holding portion from a side opposite the side on which the first stopper of said holding portion is formed, is formed on said upper fixing frame.

20. The display unit according to claim 19, wherein
a plurality of spring hooks are formed on said upper fixing frame, and a plurality of engagement protrusions engaged with said hooks are formed on said lower fixing frame.
